(19) United States
(12) Patent Application Publication
(10) Pub. No.: US 2004/0199621 A1
(43) Pub. Date: Oct. 7, 2004

(54) Systems and methods for characterizing and fingerprinting a computer data center environment

(76) Inventor: Michael Lau, Boulder, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/408,370

(22) Filed: Apr. 7, 2003

(51) Int. Cl. G06F 15/173

(52) U.S. Cl. 709/223

(57) ABSTRACT

Disclosed are novel methods and apparatus for providing characterization and fingerprinting of computer data center environments. In an embodiment, the present invention generally relates to automated, secure and dynamic methods and apparatus to characterize and/or fingerprint an entire data center hardware and/or software. In another embodiment, a detailed, time-stamped report on the entire data center or specific resources may be generated and archived for billing purposes under a services and resources provisioning scheme such as capacity on demand or utility computing. In a further embodiment, a detailed report with, for example, data center digital fingerprints can be generated in a relatively short period of time (e.g., seconds to minutes) and archived for business expansion, consolidation, disaster recovery, service provisioning, resource provisioning, capacity planning, and/or optimization.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright® 2003, Sun Microsystems, Inc., All Rights Reserved.

### FIELD OF INVENTION

The present invention generally relates to the field of computing and data center environments. More specifically, an embodiment of the present invention provides a system for characterizing and/or fingerprinting a computer data center environment.

### BACKGROUND OF INVENTION

A computer data center (also referred to as an Internet data center or an enterprise data center) may contain a myriad of computer hardware and software systems utilizing various operating systems and application software. The quantity of the hardware systems supplied by different vendors may number in the hundreds or thousands, depending on the facility or data center at issue. In addition to a multitude of hardware systems, two physically identical hardware systems may have different operating systems and/or software programs running.

Industry best practices relies on manual system by system documentation in inventory management. This is a static procedure and is both laborious and prone to human error. In fact, most data center managers are preoccupied with keeping the hardware and software systems running securely and hence a lack of urgency to obtain an accurate inventory of the software and hardware installed present in the data centers. Planning for disaster recovery, services and resources provisioning such as utility computing, business consolidation and expansion is hindered by the lack of such current and detailed information.

Some inventory management products available presently require that a program be constantly running on a machine. Such a program adds a constant overhead to systems which are often intended to be dedicated to performing a select group of tasks, such as acting as a web server or data caching, media streaming, and other applications specific tasks. Moreover, such overhead may not be necessary at all times as an inventory snapshot may not have to be obtained all the time. In addition, the constant presence of such a program consuming valuable computing resources may introduce instability in the operation of the data center systems because it may increase the likelihood of inappropriate interaction with other present software applications.

### SUMMARY OF INVENTION

The present invention, which may be implemented utilizing a general-purpose digital computer, in various embodiments, includes novel methods and apparatus to characterize and/or fingerprint computer data center environments. In an embodiment, a method of providing a report regarding a plurality of devices is disclosed. The method includes: providing a networking software agent (netbot), the netbot communicating with the plurality of devices, the netbot providing a hardware topology of the plurality of devices, the netbot querying each of the plurality of devices to determine their software configuration information; and providing a hashing software agent (hashbot), the hashbot providing a condensed representation corresponding to information provided by the netbot.

In a further embodiment of the present invention, a method of determining changes in a plurality of device profiles is disclosed. The method includes: providing a networking software agent (netbot), the netbot communicating with a plurality of devices, the netbot providing a hardware topology of the plurality of devices, the netbot querying each of the plurality of devices to determine their software configuration information; providing a hashing software agent (hashbot), the hashbot computing a checksum for each of the plurality of devices, the checksum including device profile data corresponding to information provided by the netbot; and comparing the computed checksum with a previously computed checksum to determine changes in the device profile data.

In another embodiment, a detailed, time-stamped report on the entire data center or specific resources may be generated and archived for billing purposes under a services and resources provisioning scheme such as capacity on demand or utility computing.

In yet another embodiment, a detailed report with, for example, data center digital fingerprints can be generated in a relatively short period of time (e.g., seconds to minutes) and archived for business expansion, consolidation, disaster recovery, service provisioning, resource provisioning, capacity planning, and/or optimization.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which the present invention may be embodied;

FIG. 2 illustrates an exemplarily block diagram of a data center environment 200 in accordance with an embodiment of the present invention;

FIG. 3 illustrates an exemplarily method 300 in accordance with an embodiment of the present invention; and

FIG. 4 illustrates an exemplarily checksum 400 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

In addition, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

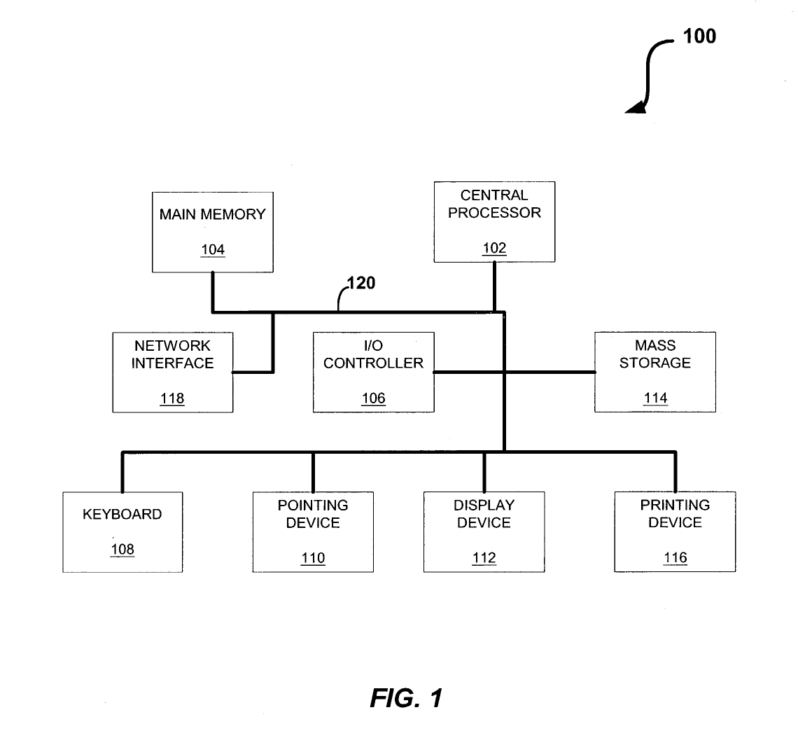

FIG. 1 illustrates an exemplary computer system 100 in which the present invention may be embodied in certain embodiments. The system 100 comprises a central processor 102, a main memory 104, an input/output (P/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In an embodiment, the computer system 100 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including Power4 and subsequent models made by IBM of Armonk, N.Y., PA-RISC, MIPS, Alpha, and Itanium chips used by Hewlett Packard of Palo Alto, Calif., and Microsoft Windows compatible personal computers and workstations utilizing Intel, AMD, Transmeta, and other. Windows-compatible microprocessors, which are available from several vendors. In addition, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a software reconfigurable processor, a very long instruction word (VLIW) microprocessor, a processor implementing a combination of instruction sets, field programmable gate arrays (FPGA) integrated circuits, and the like.

The network interface 118 provides communication capability with other computer systems on a same local network, on a different network connected via modems and the like to the present network, or to other computers across the Internet. In various embodiments, the network interface 118 can be implemented utilizing technologies including, but not limited to, wireless communications of various protocols and formats, Ethernet, Fast Ethernet, gigabit and faster Ethernet, wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, time division multiplexing (TDM), universal serial bus (USB and its varieties such as USB II), asynchronous transfer mode (ATM), satellite, cable modem, fiber channel, and/or FireWire.

Moreover, the computer system 100 may utilize operating systems such as Solaris, Windows (and its varieties such as CE, NT, 2000, XP, ME, Windows Server 2003 and the like), HP-UX, IBM-AIX, PALM, UNIX, Berkeley software distribution (BSD) UNIX, Linux implementations such as Red Hat, Red Flag, Apple UNIX (AUX), and the like. Also, it is envisioned that in certain embodiments, the computer system 100 is a general purpose computer capable of running any number of applications such as those available from companies including Oracle, Siebel, SAP, Unisys, Microsoft, and the like.

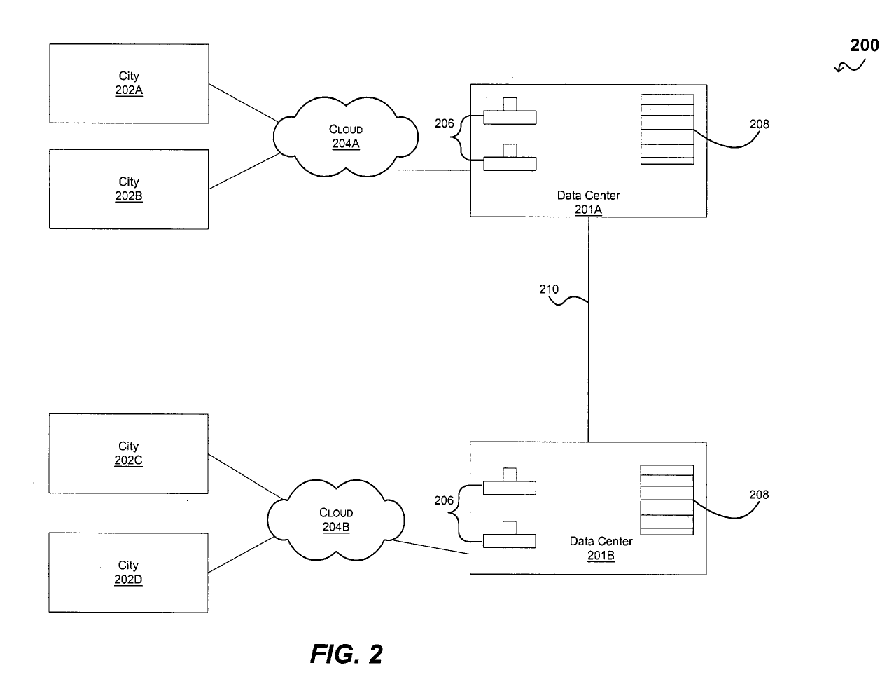

FIG. 2 illustrates an exemplarily block diagram of a data center environment 200 in accordance with an embodiment of the present invention. A data center 201A communicates with cities 202A and 202B. It is envisioned that users from the cities 202A and 202B may try to access the data center 201A through a cloud 204A. It is further envisioned that the communication between the data center 201A and the cities 202A-B may be through voice, Internet, radio signals (e.g., wireless phones, wireless personal data assistances (PDAs), satellite communication, microwave signals, and the like). It is also envisioned that users in the cities 202A-B may have computers that try to access services provided by the data center 201A.

The data center 201a may include server computers 206 and 208 including servers such as blades including those provided by Sun Microsystems, Intel Corporation, IBM, Hewlett Packard, and the like. The environment 200 may further include a data center 201B (with similar resources as the data center 201A in an embodiment). The data center 201B may communicate with the data center 201A through a communication channel 210. It is envisioned that the communication channel 210 may include any of those discussed with respect to FIG. 1, including but not limited to the network interface 118. Similarly, the data center 201B may communicate with cities 202C-D through a cloud 204B. Accordingly, it is envisioned in accordance with various embodiments of the present invention that multiple data centers may utilize different types of technology to communicate with each other and users who may be located across the globe.

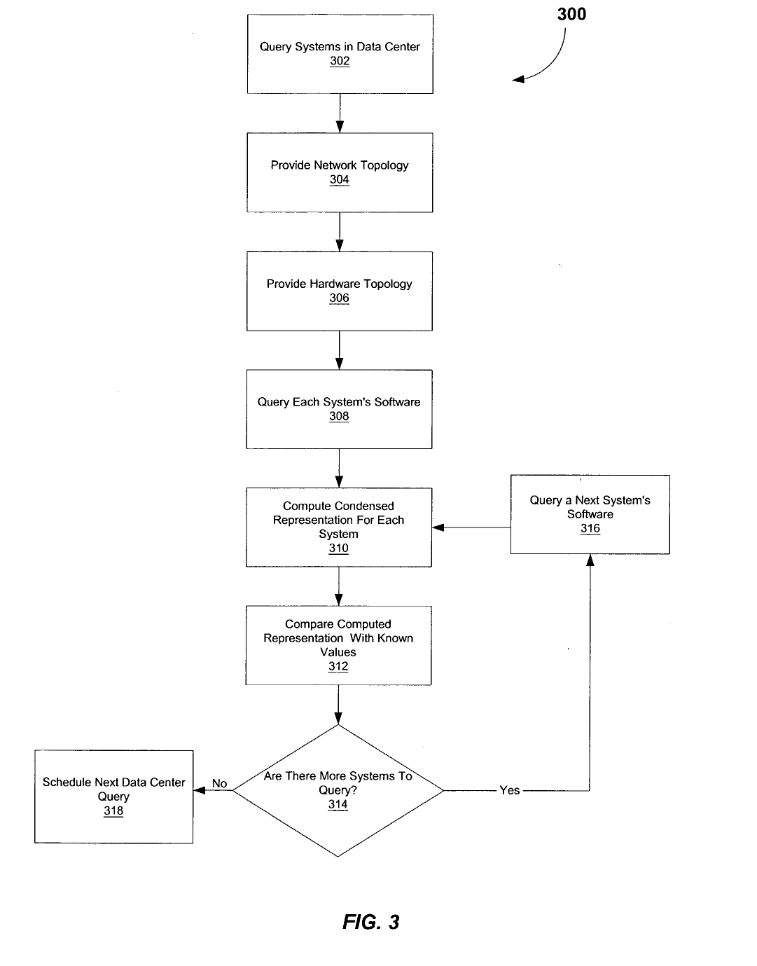

FIG. 3 illustrates an exemplarily method 300 in accordance with an embodiment of the present invention. In a stage 302, selected systems in a data center are queried. The systems queried may include functioning and nonfunctioning systems. Alternatively, all systems in a data center may be queried. In an embodiment, a network robot (NETBOT) may be utilized to query the systems in one or more data centers (such as those discussed with respect to FIG. 2). A BOT (or software agent) may be considered as a piece of software that can autonomously accomplish a task for a user or other entity. In an embodiment, the software agent may have a sort of trigger built into it and once executed the agent can carry out its function without further intervention. It is envisioned that in various embodiments of the present invention, BOTS may execute either on the Web or from a local machine.

Moreover, a software robot or software agent may be more generally utilized to provide long-lived, semi-autonomous, pro-active, and/or adapted software solutions. As such, a NETBOT can be a customizable Internet robot that can be configured for various diagnostic and/or monitoring purposes. For example, a NETBOT may be used to find out when a user logs on, keep track of web page changes, monitor Internet hosts for problems, and the like. Furthermore, NETBOTS may be implemented utilizing various modules and functionalities provided by the operating systems, or secured versions of such operating systems, running on a given system. For example, for a Microsoft Widows based systems, the Windows' registry, Active Directory services, and others may be utilized; for a Solaris based machine, the common desktop environment (CDE), GNOME, software binaries, and others may be utilized; and alike.

In a stage 304, a network topology is assembled from the information obtained in the stage 302. In a stage 306, a hardware topology may be provided based on information obtained in the stage 302. In an embodiment, the stages 304 and 306 may be combined or alternatively performed in different orders. In a stage 308, each system is queried to obtained software information regarding that system. In an embodiment, a hashing robot (HASHBOT) may be utilized to obtain software information about each system identified in the stage 302. The software information may include version, revision, and patch details, in an embodiment. A stage 310 computes a condensed representation for each system queried based on the information collected (such as collected information from any of the stages 302 through 308).

In a stage 312, the condensed representation may be compared with known values obtained from, for example, a database storing previously computed condensed representations. The known values may be computing resources capacity thresholds and/or limits imposed by the equipment vendor. The computed condensed representation may include dynamic information about hardware, software, network, capabilities, and/or configurations, for example, over a time span. The time span may indicate when a query according to the method 300 may have been performed with respect to each system. Such a time span may provide a dynamic and accurate snap shot of each individual system at a specific time, for example, specifying more precisely the services and/or resources provisioned or utilized over the specific time span. In an embodiment, a HASHBOT may be utilized to output a message digest. The length of such a digest may be 128-160 bits in an embodiment. It is envisioned that proprietary or public algorithms such as method digest 5 (MD5) and secure HASH algorithm (SHA-1) can be utilized to provide the digest.

In a stage 314, it is determined whether there are any more remaining systems to be queried. If it is determined that there are additional systems to query, a stage 316 queries a next system for software information. The method 300 then resumes in the stage 310. Alternatively, if it is determined that there are no additional systems to query (in the stage 314), a stage 318 schedules a next data center query. In one embodiment, the next query may be scheduled for hourly, daily, weekly, monthly, quarterly, and/or weekend-only execution. It is also envisioned that the next query may be more dynamically scheduled. For example, the systems within the data center may be queried for load/availability. Such data may be also stored to find trends. Based on the determined load/availability, the next query may be then scheduled for an appropriate time.

In an embodiment, it is envisioned that the method 300 may include a waiting state (not shown) following the stage 318. Such an embodiment may be especially useful to plan regular queries of a data center being modified and/or upgraded, or entitlement of additional resources in a vendor specified capacity on demand scheme. The method 300 may resume at the stage 302 for a next data center query. Accordingly, in an embodiment, the present invention provides an accurate picture of what is inside a data center (e.g., software and/or hardware). The accurate picture will enable an efficient disaster recovery, services and resources provisioning such as utility computing, expansion, consolidation, and/or optimization associated with computer systems maintained within a data center environment.

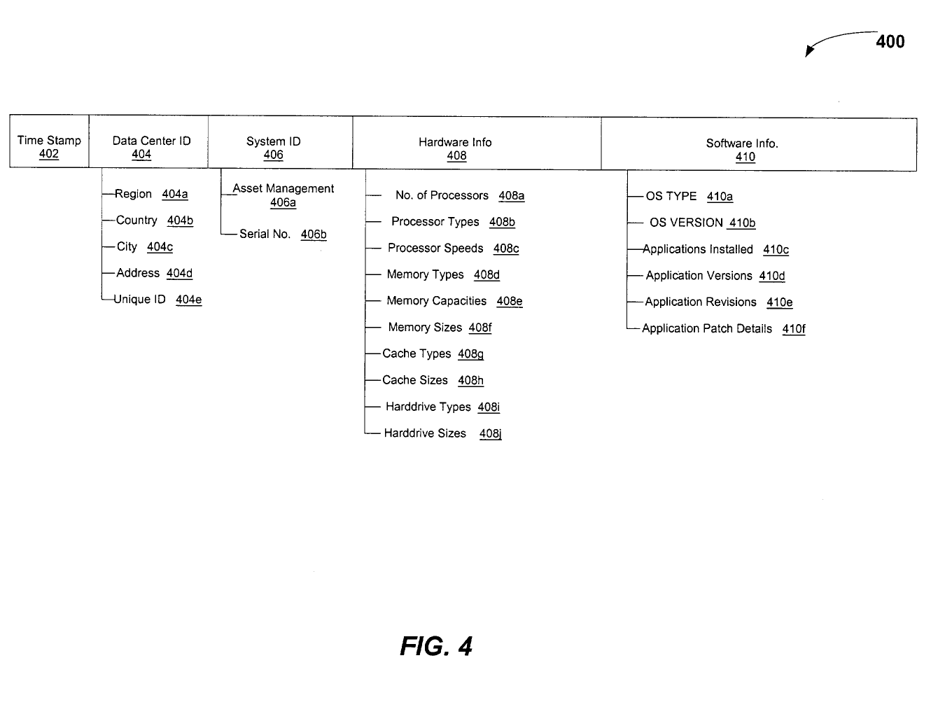

FIG. 4 illustrates an exemplarily checksum 400 in accordance with an embodiment of the present invention. The checksum 400 includes a time stamp field 402, a data center identity (ID) 404, a system ID 406, a hardware info field 408, and/or a software info field 410. The time stamp field 402 may include information about when a query has been performed on a given system in accordance with, for example, the method 300 of FIG. 3. In an embodiment, it is envisioned that the checksum 400 may be computed for each system in a data center(s) such as discussed with respect to FIG. 3.

The data center ID 404 may include information regarding the location and/or the identity of the data center. For example, the data center ID 404 may include region, country, city, address, and/or unique ID information. The unique ID may be a serial number unique to the data center being queried, e.g., in accordance with the method 300 of FIG. 3. The system ID 406 may include information about the system that the checksum 400 is being computed for. The system ID 406 may include asset management information such as an asset management number 406A and/or serial number 406B. The hardware info 408 field may include hardware information about the system being queried, e.g., in accordance with the method 300, such as the number of processors installed 408A, processor types 408B, processor speeds 408C, memory types 408D (such as those discussed with respect to FIG. 1), memory capacities 408E, memory sizes 408F, cache memory types 408G, cache sizes 408H, hard drive types 4081, and/or hard drive sizes 408J.

The software info field 410 may include operating system (OS) type 410A, OS version 410B, applications installed 410C, application versions 410D, application revisions 410E, and/or application patch details 410F. Accordingly, the checksum 400 may include information regarding each system in a concise format such that the checksum may be compare with other checksums associated with the same system and thereby indicating any changes (e.g., chronology) to keep track of any modifications associated with that given system (e.g., see also the discussion with respect to FIG. 3). The length of such the checksum 400 may be 128 to 160 bits, in an embodiment. In another embodiment, the checksum 400 may be implemented similar to the digest discussed with respect to FIG. 3. In a further embodiment, the checksum 400 may be encrypted for security purposes. For example, if the checksum is calculated at a remote location, encryption may enhance security over the Internet.

Accordingly, in one embodiment, the present invention generally relates to automated and secure methods and apparatus to characterize an entire data center hardware and/or software. In another embodiment, a detailed, time-stamped report on the entire data center or specific resources may be generated and archived for billing purposes under a services and resources provisioning scheme such as capacity on demand or utility computing. In a further embodiment, a detailed report with digital fingerprints can be generated in a relatively short period of time (e.g., seconds to minutes) and archived for future business expansion, consolidation, and/or optimization.

In a further embodiment, Solaris fingerprint technology (available from Sun Microsystems, Inc.) can be utilized to provide discrete functionality in accordance with various embodiments of the present invention. Certain hash algorithms such as MD5 and SHA-1 may also be utilized to implement various embodiments of the present invention. Further information regarding the latter algorithms may be found at NIST.org (such as publications 1480-2 and 180-1).

The foregoing description has been directed to specific embodiments. It will be apparent to those with ordinary skill in the art that modifications may be made to the described embodiments, with the attainment of all or some of the advantages. For example, the techniques of the present invention may be applied to any type of inventory management system. Also, a dedicated machine is not required to provide embodiments of the present invention. Instead, the computing may be distributed for security and/or disaster recovery. Therefore, it is the object of the appended claims to cover all such variations and modifications as come within the spirit and scope of the invention.

What is claimed is:

1. A method of providing a report regarding a plurality of devices, the method comprising:
providing a networking software agent (netbot), the netbot communicating with the plurality of devices, the netbot providing a hardware topology of the plurality of devices, the netbot querying each of the plurality of devices to determine their software configuration information; and
providing a hashing software agent (hashbot), the hashbot providing a condensed representation corresponding to information provided by the netbot.

2. The method of claim 1 wherein the netbot determines which of the plurality of devices are functioning.

3. The method of claim 2 wherein the netbot only queries a device from the plurality of devices which has been determined to be functioning.

4. The method of claim 1 wherein the netbot determines the service level of functionality of the plurality of devices.

5. The method of claim 4 wherein the netbot only queries a device from the plurality of devices which has been determined to be functioning at the service level of functionality.

6. The method of claim 1 wherein the hashbot provides a condensed representation for each of the plurality of devices.

7. The method of claim 1 wherein the condensed representation is utilized for an item selected from a group comprising business expansion, consolidation, disaster recovery, service provisioning, resource provisioning, capacity planning, and optimization.

8. The method of claim 1 wherein the hashbot provides a condensed representation for an aggregate of all the devices.

9. The method of claim 1 wherein the software configuration information is selected from a group comprising version, revision, and patch detail.

10. The method of claim 1 wherein the plurality of devices are present in a data center.

11. The method of claim 1 wherein the plurality of devices are present in a plurality of data centers.

12. The method of claim 11 wherein the plurality of data centers communicate with each other.

13. The method of claim 1 wherein the netbot further provides a network topology of the plurality of devices.

14. The method of claim 1 wherein the hashbot utilizes a proprietary or public algorithm selected from a group comprising MD5 and SHA-1.

15. A method of determining changes in a plurality of device profiles, the method comprising:
providing a networking software agent (netbot), the netbot communicating with a plurality of devices, the netbot providing a hardware topology of the plurality of devices, the netbot querying each of the plurality of devices to determine their software configuration information;
providing a hashing software agent (hashbot), the hashbot computing a checksum for each of the plurality of devices, the checksum including device profile data corresponding to information provided by the netbot; and
comparing the computed checksum with a previously computed checksum to determine changes in the device profile data.

16. The method of claim 15 wherein the previously computed checksum is stored in a database.

17. The method of claim 15 further including storing the computed checksum in a database.

18. The method of claim 15 wherein the checksum is encrypted.

19. The method of claim 15 wherein the checksum includes information selected from a group comprising a time stamp, a data center ID, a system ID, hardware information, and software information.

20. The method of claim 15 wherein the netbot determines which of the plurality of devices are functioning.

21. The method of claim 20 wherein the hashbot only queries a device from the plurality of devices which has been determined to be functioning.

22. The method of claim 15 wherein the netbot determines the service level of functionality of the plurality of devices.

23. The method of claim 22 wherein the netbot only queries a device from the plurality of devices which has been determined to be functioning at the service level of functionality.

24. The method of claim 15 wherein the hashbot computes the checksum.

25. The method of claim 15 wherein the plurality of devices are present in a data center.

26. The method of claim 15 wherein the plurality of devices are present in a plurality of data centers.

27. The method of claim 15 wherein the plurality of data centers communicate with each other.

28. The method of claim 15 wherein the hashbot utilizes an algorithm selected from a group comprising MD5 and SHA-1.

29. The method of claim 15 wherein the computed checksum is utilized for an item selected from a group comprising business expansion, consolidation, disaster recovery, service provisioning, resource provisioning, capacity planning, and optimization.

30. An article of manufacture for determining changes in a plurality of device profiles, the article comprising:
a machine readable medium that provides instructions that, if executed by a machine, will cause the machine to perform operations including:
providing a networking software agent (netbot), the netbot communicating with a plurality of devices, the netbot providing a hardware topology of the plurality of devices, the netbot querying each of the plurality of devices to determine their software configuration information;
providing a hashing software agent (hashbot), the hashbot computing a checksum for each of the plurality of devices, the checksum including device profile data corresponding to information provided by the netbot; and
comparing the computed checksum with a previously computed checksum to determine changes in the device profile data.

31. The article of claim 30 wherein the operations further include storing the computed checksum in a database.

32. The article of claim 30 wherein the plurality of devices are present in a data center.

33. The article of claim 30 wherein the computed checksum is utilized for an item selected from a group comprising business expansion, consolidation, disaster recovery, service provisioning, resource provisioning, capacity planning, and optimization.

34. An article of manufacture for providing a report regarding a plurality of devices, the article comprising:
a machine readable medium that provides instructions that, if executed by a machine, will cause the machine to perform operations including:
providing a networking software agent (netbot), the netbot communicating with the plurality of devices, the netbot providing a hardware topology of the plurality of devices, the netbot querying each of the plurality of devices to determine their software configuration information; and
providing a hashing software agent (hashbot), the hashbot providing a condensed representation corresponding to information provided by the netbot.

35. The article of claim 34 wherein the hashbot provides a condensed representation for each of the plurality of devices.

36. The article of claim 35 wherein the condensed representation is utilized for an item selected from a group comprising business expansion, consolidation, disaster recovery, service provisioning, resource provisioning, capacity planning, and optimization.
